(19) United States
(12) Patent Application Publication
(10) Pub. No.: US 2008/0252737 A1
(43) Pub. Date: Oct. 16, 2008

(54) Method and Apparatus for Providing an Interactive Control System

(75) Inventors: Frederick T. Morehouse, Flemington, NJ (US); Jack E. Surline, Langhome, PA (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 11/734,398

(22) Filed: Apr. 12, 2007

(51) Int. Cl. H04N 5/228

(52) U.S. Cl. 348/222.1

(57) ABSTRACT

An apparatus includes an imaging device that captures a plurality of positional signals emitted from an interactive control device, which is moveable in a three-dimensional control space in the field of view of the imaging device, to form a two-dimensional image having one or more control points. Further, the apparatus includes a display that has a display control area in which a positional signal object and one or more control objects are displayed for interaction with the interactive control device. In addition, the apparatus includes a processor that that generates a positional signal object based on the one or more control points and maps the one or more control objects and the positional signal object to a data structure so that an interaction between the one or more control objects and the positional signal object is spatially-synchronized. The positional signal object and the one or more control objects are rendered in the display control area.

### BACKGROUND

1. Field

This disclosure generally relates to the field of interactive devices. More particularly, the disclosure relates to a device that allows a user to remotely interact with a system.

2. General Background

A variety of display systems, e.g. televisions, home theater systems, computers, etc., have vastly evolved to provide more functionality to the user. At the same time, the user interfaces displayed on these systems have become increasingly complex. Controlling the user interface with a standard remote control, or even a universal remote control, is often quite cumbersome. The number of buttons on a remote control has increased as a result of the number of possible operations for the user interface. The user is often faced with having to find a button out of a large number of buttons to perform even a simple operation.

For example, a home theater system may have multiple set top boxes that are networked with many other fixed or mobile devices throughout the home. A conventional remote control is simply too cumbersome for the multitude of operations that are often utilized in this type of powerful home media system. The large number of buttons built into a conventional remote control to provide such a multitude of operations ultimately causes frustration for most users. Many functions are not utilized because the user cannot find, or loses patience trying to find, the corresponding button. Further, the user may have even more difficulty finding a button in a low-light environment, e.g., a dark room for watching a movie.

In addition, the conventional remote control does not provide the user with much flexibility to expand the home theater system. For instance, adding a component to the home theater system may provide additional expense to the user who may then have to purchase a new remote control with additional buttons to accommodate the expansion.

Alternatively, menu-based systems are sometimes utilized for powerful home media systems. Menu-based systems often simplify the remote control while at the same time complicating the user interface. In other words, an operation may not have a corresponding button on the conventional remote control, but rather an additional menu item for selection. The user may then utilize the arrow keys on the conventional remote control to navigate through menus to perform an operation. Therefore, a large number of menu items are often composed for a user interface in a powerful home media system to accommodate the large number of operations in such a system. As a result, the user may have to navigate through large lists of digital content or many menu levels to perform even a simple operation.

### SUMMARY

In one aspect of the disclosure, an apparatus is disclosed. The apparatus includes an imaging device an imaging device that captures a plurality of positional signals emitted from an interactive control device, which is moveable in a three-dimensional control space in the field of view of the imaging device, to form a two-dimensional image having one or more control points. Further, the apparatus includes a display that has a display control area in which a positional signal object and one or more control objects are displayed for interaction with the interactive control device. In addition, the apparatus includes a processor that that generates a positional signal object based on the one or more control points and maps the one or more control objects and the positional signal object to a data structure so that an interaction between the one or more control objects and the positional signal object is spatially-synchronized. The positional signal object and the one or more control objects are rendered in the display control area.

In another aspect of the disclosure, an apparatus is disclosed. The apparatus includes a light source that emits a positional signal that is in a field of view of an imaging device and is tracked, according to a two-dimensional coordinate system of a control plane in the field of view of the imaging device, so that control plane two-dimensional coordinates of the positional signal are translated into display two-dimensional coordinates of the positional signal. The display two-dimensional coordinates are based on a two-dimensional coordinate system of a display. Further, the apparatus includes an activation button that is activated to provide a command signal indicating a command associated with a context of a system associated with the display.

In yet another aspect of the disclosure, an apparatus is disclosed. The apparatus includes a lens module. Further, the apparatus includes an imaging sensor that captures, through the lens module, a plurality of positional signals emitted from an interactive control device that is moveable in a three-dimensional control space and forms a two-dimensional image having one or more control points so that a processor generates a positional signal object based on the one or more control points.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a system that utilizes an interactive control device.

FIG. 2 illustrates an enlarged view of the interactive control device.

FIG. 3A illustrates a three-dimensional control space in which the interactive control device is situated.

FIG. 3B illustrates how the imaging device captures the position of the light source of the interactive control device, which moves within a control plane.

FIG. 3C illustrates a two dimensional perspective of the location of the interactive control device with respect to the imaging device.

FIG. 3D illustrates another two dimensional perspective of the location of the interactive control device with respect to the imaging device.

FIG. 3E illustrates how the focus and zoom capabilities are implemented for better resolution for the mapping of the coordinates of the location of the light source to the coordinates of the display in the display system.

FIG. 3F illustrates the mapping of the coordinates of the location of the light source to the coordinates of the display in the display system.

FIG. 4 illustrates a process utilized by the interactive control system.

FIG. 5 illustrates a process utilized by the interactive control device.

FIG. 6 illustrates a process utilized by the imaging device.

FIG. 7 illustrates a block diagram of a station or system that implements processing of the data received from the interactive control device.

### DETAILED DESCRIPTION

A method and apparatus are disclosed, which provide an interactive control system. The interactive control system may provide a user with cursor-based point-and-click functionality for interacting remotely with a display system. Accordingly, the feature set normally present on a remote control device through a plethora of buttons is decoupled from the interactive control device. Further, the interactive control device may be operated through mid-air navigation. Thus, the user may operate the interactive control device without a flat surface, which is normally utilized by a device such as a computer mouse. As a result, a user may interact with the display system in a fast, comfortable, and vastly simplified manner.

In addition, the interactive control system involves position determinations and command actions that are not dependent on a particular display system. The feature set and controls of the interactive control system are utilized with respect to displayed control objects on the display system. Accordingly, the interactive control system need not be modified to accommodate changes to the display system. The feature set may be simply updated with changes to the equipment utilized in the display system.

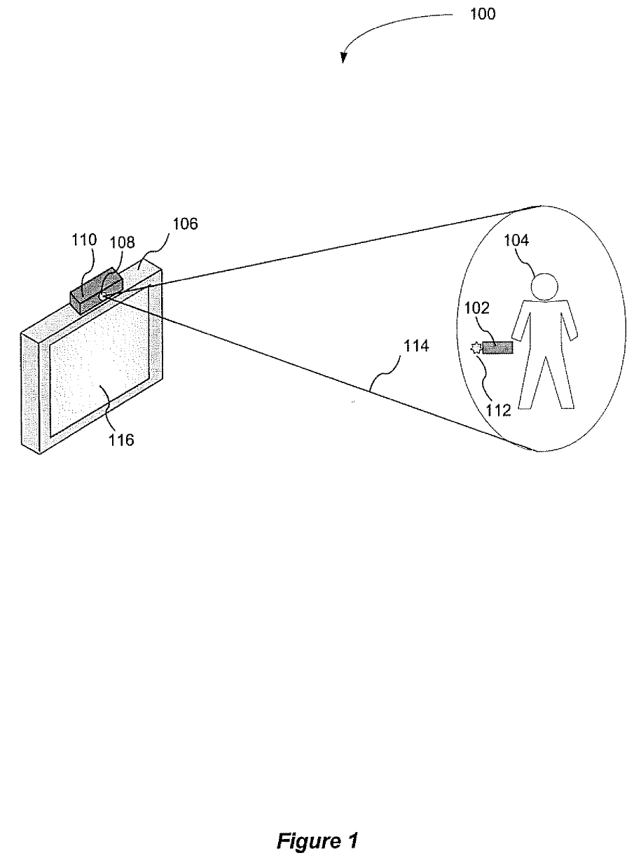

FIG. 1 illustrates an interactive control system 100 that utilizes an interactive control device 102 and an imaging device 108. A user 104 may utilize an interactive control device 102 to interact with a display system 106. The display system 106 may include any type of device having a display, e.g., television, home theater system, personal computer, personal computer tablet, laptop, or the like. Further, the display system 106 has a display 116, i.e., a two-dimensional array of picture elements (“pixels”), which are the smallest units of the display 116. In one embodiment, the display 116 has a display control area, e.g., a rectangular section, that the display 116 utilized for cursor motion and control activations. The rectangular section may be the same size as the display 116. Alternatively, the rectangular section may be smaller than the display 116. The display control area may be any of a variety of shapes, e.g., square, circle, etc., and is not limited to a rectangular section.

The display 116 may display a control screen, which is a layout of control objects that may vary with the state of the system being controlled such that control operations are made available in a user-friendly way. The format of the control screen may be based on the display format, e.g. widescreen, letter box, etc. The control objects may be individual icons, cursors, buttons, or other graphical objects which provide the user 104 with targets and a pointer/cursor for control operations.

The user 104 may be viewing a menu displayed in the display control area of the display 116 and wish to interact with the menu. Accordingly, the user 104 may move the interactive control device 102 in order to move a cursor on the display system 106 to an intended menu selection. The system 100 provides this functionality with the imaging device 108, which tracks the movement of the interactive control device 102. To track the movement, the imaging device 108 receives one or more positional signals emitted from the interactive control device 102. For instance, the interactive control device 102 may emit a recognizable light pulse sequence from a light source 112, and the imaging device 108 may detect the two-dimensional positions of the light pulses through a lens and a sensor grid. In other words, each light pulse may be seen by the imaging device 108 as a dot in the field of view 114 of the imaging device 108. The imaging device 108 may then provide the two-dimensional coordinates or one or more of the stimulated grid points to a processor in a set top box 110. Alternatively, the imaging device 108 may provide an image capture, which is a set of stored pixels as imaged onto an imaging device sensor matrix in a two dimensional representation from the field of view 114 of the imaging device 108.

The processor may then map the two-dimensional coordinates of the one or more points captured by the imaging device 108 onto the control screen as one or more control points. In one embodiment, the processor stores the two-dimensional coordinates of a control point captured by the imaging device 108 and the control objects of the control screen in a data structure. For example, the control data structure processor may store pixel values for the control point captured by the imaging device 108 and the control objects in a matrix. At a given time, if the mapped control point captured by the imaging device 108 is in the same location of the matrix as a control object, the processor determines that the user 104 intended a selection of the control object by the user 104. Accordingly, the processor may then perform the operation indicated by the user 104. Whether or not the point captured by the imaging device 108 overlaps with a control object, the processor provides a plurality of pixel values to the display 116 so that a graphical representation of the control screen, with the control objects and icon representing the point captured by the imaging device 108, may be displayed. In one embodiment, the processor transfers the data structure to the display system 106 so that the data structure may be rendered onto the display 116. The processor may provide formation and sizing of intermediate arrays or streams such that the data structure may be transferred to and represented on the display 116. Alternatively, the processor may separate the data structure components and transfer the components separately if the hardware or other system constraints exist.

The processor may map the two-dimensional coordinates of the control point captured by the imaging device 108 to the two-dimensional coordinate system of the display 116 in the display system 106. For instance, the two-dimensional rectangular area of the display may be twice that of the interactive control device 102 range of motion, i.e., the mid-air control plane area. Accordingly, the processor may map the two-dimensional coordinates of the control plane area to the two-dimensional coordinates of the display system 106. This mapping effectively scales the two-dimensional positions of the light pulses so that the motion of the cursor in the display corresponds to the motion of the interactive control device 102. The shape of the control plane may be similar to that of the display system 106.

Further, the imaging device 108 and related processing logic may have ability to focus and zoom in or out such that a user 104 may operate the interactive control device 102 in mid-air at various distances from the imaging device 108. The zoom is an optical and/or digital manipulation of visual perspective in a simulation of viewpoint advance, i.e., zoom in, or retreat, i.e., zoom out. Optical zoom is accomplished by an Imaging lens system. Digital “zoom in” is accomplished by a process of reducing the number of picture elements, i.e., cropping, and remapping those elements back to the original array size with some multiplicity and possibly altered values to simulate an overall enlargement.

Based on user settings, manual or automatic optical zoom, or predetermined output characteristics of the interactive control device 102, the control plane dimensions within the field of view 114 may be identified by the system 100. For example, a user 104 may initiate a calibration sequence in which a test motion may be utilized to identify to the imaging device 108 the user's desired two dimensional range of motion.

Further, if the display control area is smaller than the display 116, the processor stores x and/or y boundary values such that the feedback to the user 104 is limited cursor movement in the display 116. The boundary value(s) may be established for specific purposes by a user setting, or may be application-controlled, i.e., automatically set per context.

In one embodiment, the imaging device 108 includes a lens module and grid-based image capture subsystem. For instance, the imaging device 108 may have an imaging sensor that has an infrared grid sensor with resolution on the order of 1.0 Megapixels such that illuminated pixels translate to discrete coordinates. The imaging sensor tracks the peak of the light source 112 of the interactive control device 102 through a lens. Further, the imaging device may interface with a processor in the set top box 110 to register the location of the interactive control device 102 and button activations. Although the imaging device 108 is illustrated as being part of the set top box 110, the imaging device 108 may also be plugged into the set top box 110 so that the imaging device 108 is a part of the set top box 110 or distinct from the set top box, but in communication with the set top box 110. Further, the lens module may include a lens configuration of one or more lenses.

In another embodiment, the positional signal is an infrared signal. Further, the infrared signal may be emitted in an encoded pulse format to distinguish the interactive control device 102 from other devices or ambient conditions. In other words, varied pulse patterns may be utilized for similar interactive devices 102 to provide uniqueness to different interactive control devices 102. Further, the encoded pulse formats may also allow for command patterns to be recognizable by the imaging device 108 and supporting processing logic. Alternatively, a device separate from the imaging device 108 may be utilized to receive and recognize command patterns while the imaging device 108 simultaneously tracks position.

In one embodiment, the imaging device 108 is integrated into a set top box 110 utilized in conjunction with the display system 106. Further, the imaging device 108 may have a communication module to transmit the coordinate data to a processor in the set top box 110. Accordingly, the processor in the set top box 110 utilizes the two-dimensional data from the imaging device 108 to display an image representing the position of the interactive control device 102 on the display system 106. For example, a cursor or an icon may be displayed on the display system 106 to indicate the position of the interactive control device 102. In one embodiment, the processor in the set top box 110 translates control plane two-dimensional data, e.g., the set of two-dimensional coordinates received from the imaging device 108, into display two-dimensional data, e.g., two-dimensional coordinates of the display system 106, and initiates rendering of the cursor therein. In one embodiment, the initial cursor speed may be determined by a calibration step in which the user 104 moves the interactive control device 102 over the desired two-dimensional space. The processor in the set top box 110 then creates the mapping from that area to the dimensions of the display screen in the display system 106. Auto calibration may also be utilized. Further, predetermined screen layouts may be maintained in accordance with both system state and accurate real-time cursor positioning. At any given time when a command is initiated, the correlation between cursor position and displayed screen objects determines the ensuing function. Accordingly, a context sensitive user interface presentation may be supported utilizing screen objects that appear based on context of operation. In other words, a user is presented with control options based on specifics of the operating state or context. Therefore, the interactive control device 102 provides functionality based on a given context in contrast with a conventional remote control that only provides static functionality through a dedicated set of buttons irrespective of changing contexts.

The perception of continuous cursor motion will be attained by sufficiently sampling the motion data captured within the imaging device 108 and rapidly updating the cursor. Further, if the user 104 moves the interactive control device 102 such that the signals are outside of the purview of the imaging device 108, the cursor stays visible along the outer edge of the display screen of the display system 106 until the signals are within the purview of the imaging device 108.

Once the user has effectively moved a cursor or icon to an intended location on the display screen, the user may wish to perform an action. In the example above, the user 104 may have moved the cursor from the left hand side of the control screen to the right hand side of the control screen to place the cursor over a menu item. In one embodiment, the user 104 selects the menu item by activating a button. Accordingly, a command signal is emitted from the interactive control device 102. The command signal may also be emitted through a signal such as an infrared signal. Further the command signal may be emitted through an infrared signal in a pulse format. In another embodiment, the command signal may also be emitted through a radio wave. The command signal may be transmitted in the same or different form than the positional signal.

In another embodiment, the user 104 issues a command through a predetermined motion of the interactive control device 102. This type of motion-based control may be set by standard default motions or customized by the user 104. For instance, while playing a recording, the user 104 may issue the fast forward command by moving the interactive control device 102 from left to right across the viewing area of the imaging device 108. Further, the user 104 may issue the rewind command by moving the interactive control device 102 from right to left across the viewing area of the imaging device 108. In addition, the user 104 may issue the stop command by moving the interactive control device 102 in a downward motion. Motion-based control may be implemented for trick plays, which include playback operations such as rewind, fast forward, pause, and the like.

Further, the pre-determined motions may represent different commands in different contexts. For instance, the downward motion may issue a stop command in the context of playing a recording while issuing a channel change command in the context of watching live television. A motion may be predetermined to change contexts, e.g., an upward motion. The motion commands may also be utilized to change volume, e.g., an upward motion indicates an increase in volume where as a downward motion indicates a decrease in volume.

In one embodiment, the processor may store a buffer of previous values for the control objects and points captured by the imaging device 108. Accordingly, the processor may determine when a predetermined motion for a command has occurred by monitoring the contents of the buffer for a predetermined sequence of values corresponding to the predetermined motion.

In one embodiment, the user 104 may customize the predetermined motion of the interactive control device 102. The processor has the capability to learn a command and a corresponding predetermined pattern that the processor receives from the user 104 so that the processor recognizes the pattern at future times. As a result, the processor will know what command to perform when receiving a plurality of coordinates indicative of the pattern.

In another embodiment, the imaging device 108 may have an additional and distinct processor from the processor in the set top box 110. The additional processor in the imaging device 108 may be utilized to perform a variety of functions. For instance, the additional processor in the imaging device 108 may determine a representative code for plurality of coordinates and send the representative code, rather than the plurality of coordinates, to the processor in the set top box 110. Accordingly, the additional processor may send a control output, such as the plurality of coordinates, a representative code, or the like to the processor in the set top box 110 for a positional signal or a motion command by the interactive control device 102.

In one embodiment, the interactive control device 102 begins emitting signals with a button click by the user 104. For instance, the first signal in a control session may initiate an application display and position the cursor in the center of the display screen of the display system 106. In another embodiment, if the interactive control device 102 is inactive for a timeout period, the interactive control device 102 stops emitting signals and waits for the user 104 to initiate a button click of the interactive control device 102 before emitting signals again. In another embodiment, the interactive control device 102 has an embedded sensor capable of detecting video screen presence, and when such detection is attained, the interactive control device 102 spontaneously begins a signal emitting sequence for the purpose of starting cursor-based control with the display. After a timeout period, the signal may cease so that power is conserved.

The imaging device 108 may be built into the display system 106 or integrated into an existing display system 106. For instance, the imaging device 108 may be attached to an existing set top box 110 through a USB connection. Further, the interactive control device 102 may be utilized with a display system 106 that has a built in or integrated imaging device 108.

In one embodiment, the set top box 110 supports device drivers. Further, the set top box 110 also supports an application programming interface (“API”). Accordingly, the processor in the set top box 110 translates the two-dimensional data received from the imaging device 108 and is not dependent on a particular imaging device 108.

The interactive control device 102 provides a low-cost reliable method for manipulating screen-based menus. Accordingly, the interactive control device 102 is particularly helpful for applications in which a desktop mouse is infeasible and keyboards and complex remote controllers are cumbersome. The interactive control device 102 allows the user 104 to operate in a free-space plane in front of the user 104. As a result, the user 104 is not constrained by range or surfaces for operation. Further, the interactive control device 102 allows for pointing and activating, which is a very natural approach for many users 104. In addition, the interactive control device 102 is helpful to users 104 with visual or physical disabilities.

In an alternative embodiment, the positional signal is emitted from a light source 112 of the interactive control device 102 indicates a set of three-dimensional coordinates for the position of the interactive control device 102 in the three dimensional coordinate space of the user 104. In other words, the interactive control device 102 may have a processor and a positioning module that determines the three dimensional position of the interactive control device 102. The interactive control device 102 may then transmit the three-dimensional data to a receiver device, which may then extract the two-dimensional coordinates from the three-dimensional coordinate. Alternatively, the interactive control device 102 may send a positional signal with the two-dimensional position of the interactive control device 102 so that the imaging device 108 does not have to extract data. The receiver device may then provide the two-dimensional data to the processor in the set top box 110 for mapping to the two-dimensional coordinate system of the display 116 in the display system 106. The data for the positional signal may be transmitted in the form of packets.

An example of the interactive control system 100 in operation is the light source 112 on the interactive control device 102 activating. The zoom level is then set, or is already set. Further, the user 104 moves the interactive control device 102, and thereby moves the light source 112, a reasonable distance and observes the tracking cursor moving toward a control object of choice. The user 104 lands the cursor on the control object, and the interactive control system 100 is aware that the cursor position coincides with the control object because the interactive control system 100 placed the objects in place. At the time that the user “click-activates” the object, the function associated with the object executes. The displayed interactive control system-related objects, e.g. Buttons and cursor, are known in their relative positioning prior to being mapped for display. In other words, those control objects may initially reside on a single (common) data structure, e.g., matrix.

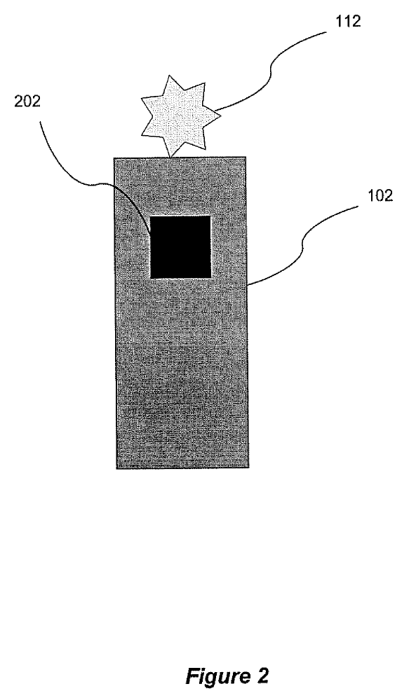

FIG. 2 illustrates an enlarged view of the interactive control device 102. The interactive control device 102 may be implemented in a device that has one or more buttons 202 for point and click functionality, and the light source 112 for sending one or more signals. For instance, the light source may send infrared signals. One of ordinary skill in the art will understand that a variety of types of light may be utilized in conjunction with the light source 112.

The interactive control device 102 may be any one of a variety of different shapes and configurations. For instance, the interactive control 102 device may be in the shape of a pen. Further, the button 202 may be situated on any portion of the interactive control device 102. For instance, the button 202 may be positioned on one end of a pen shaped configuration so that the button 202 may be activated by the thumb of a user 104. In addition, the interactive control device 102 may have one or more attachments to assist the user 104 with a comfortable free range motion. For example, a ring may be attached to the interactive control device 102 so that the user 104 can easily position interactive control device 102 and still utilize his or her hand for performing other tasks, e.g., writing, eating, drinking, etc. Although the button 202 is illustrated, a plurality of buttons may be utilized. Further, other types of actuators may be utilized in place of or in addition to the button 202. For instance, a knob, switch, etc. may be utilized.

In another embodiment, the interactive control device 102 may be implemented as a part of another device that has an actuator and a light source. For instance, a cell phone, Personal Digital Assistant (“PDA”), MP3 player, etc., may be configured to be the interactive control device 102.

In one embodiment, the light source 112 emits encoded signals in a pulse format. Accordingly, the interactive control device 102 may be utilized by a user 104 irrespective of ambient light conditions. In other words, the amount of surrounding light in a room, e.g., a well lit room or a dark room, does not hamper the operation of the interactive control device 102.

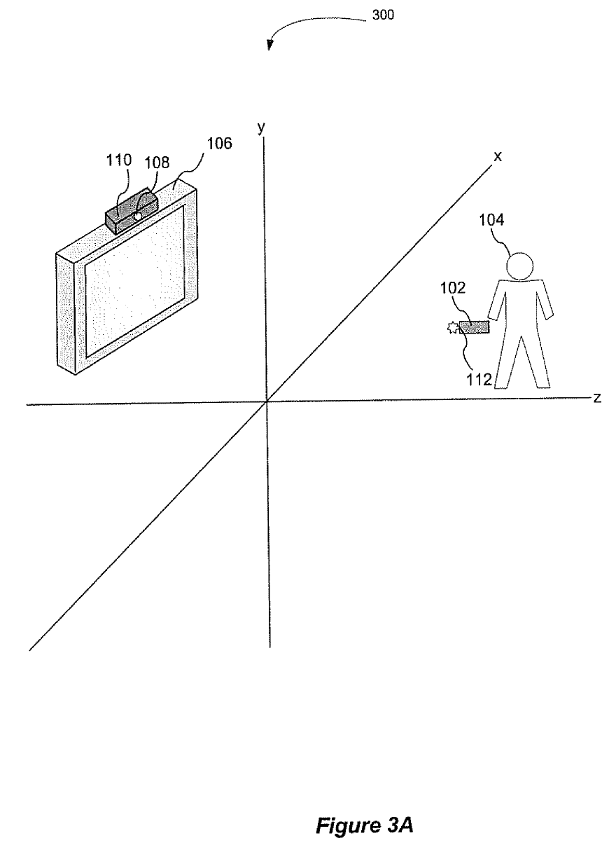

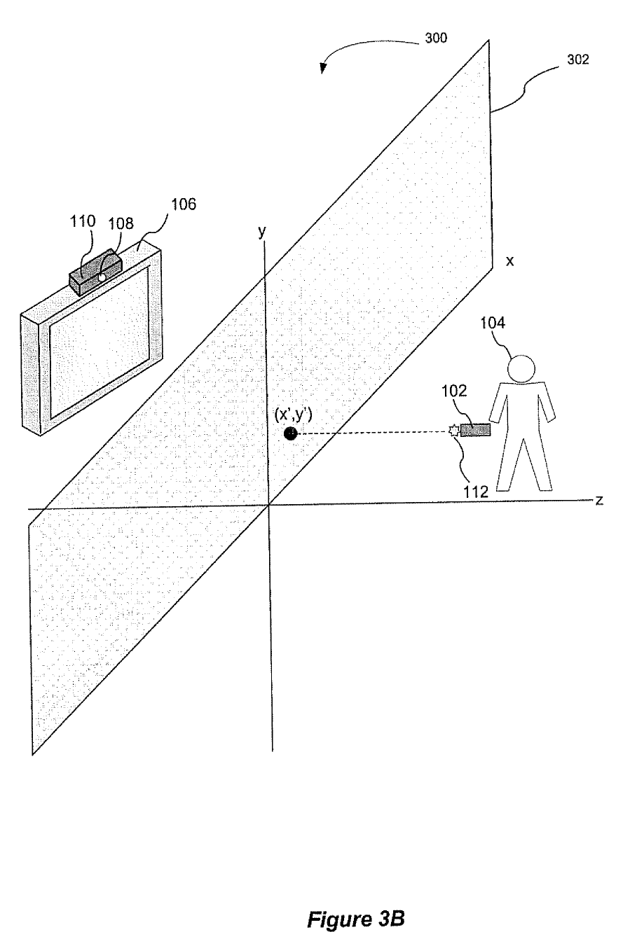

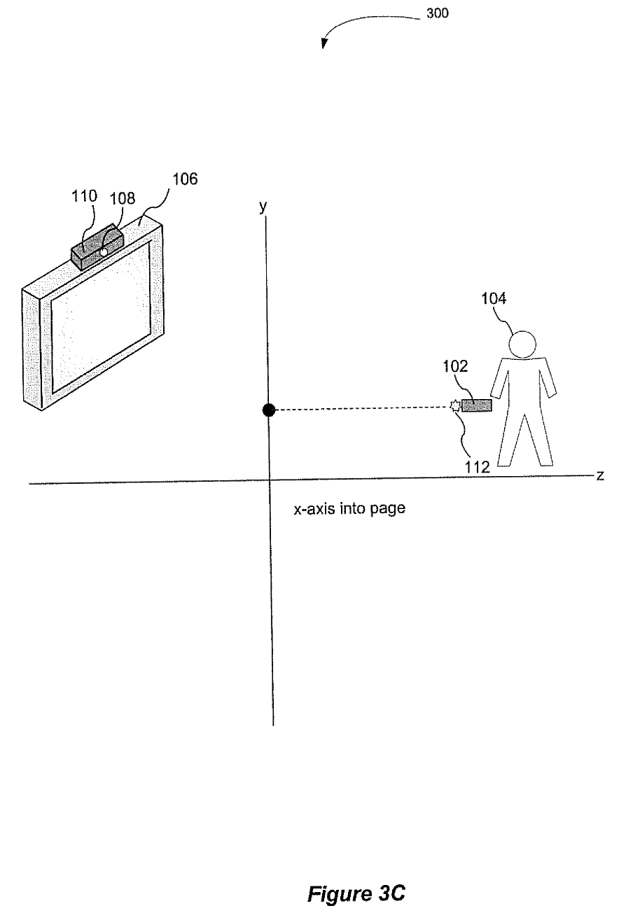

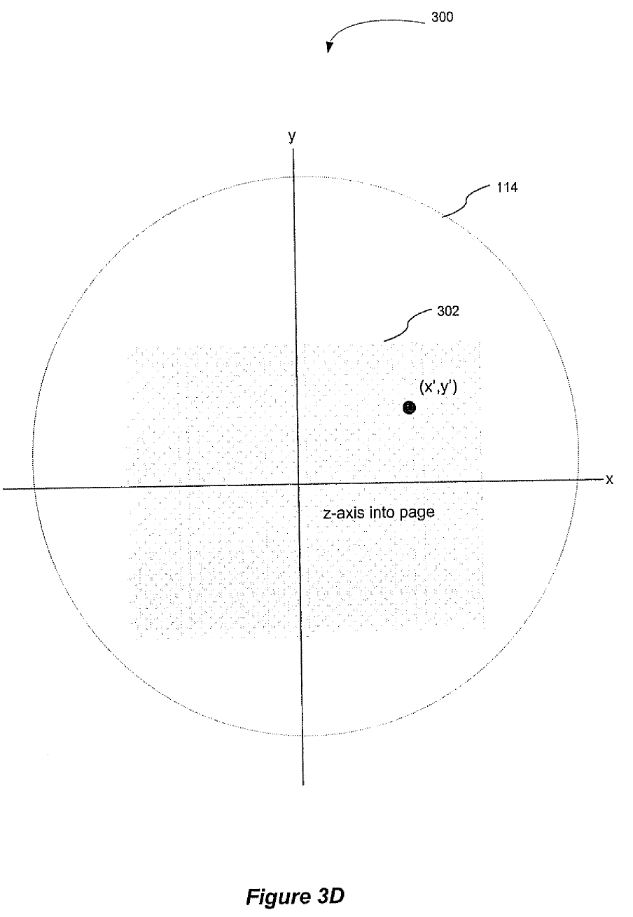

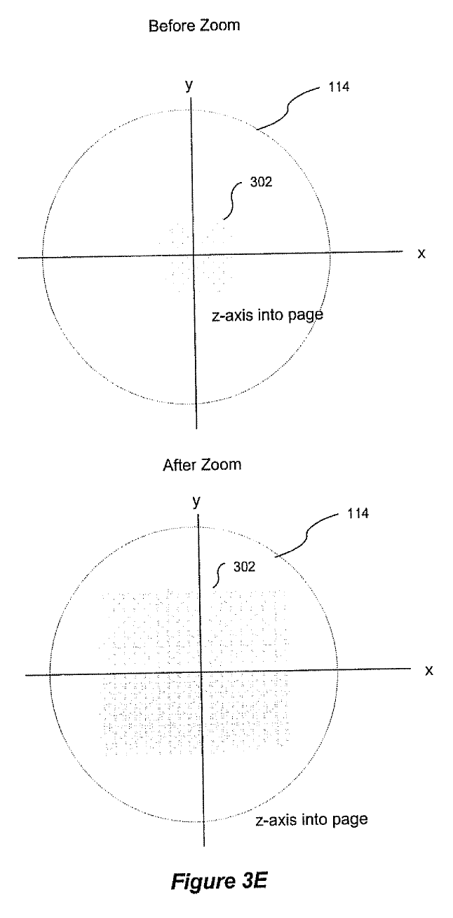

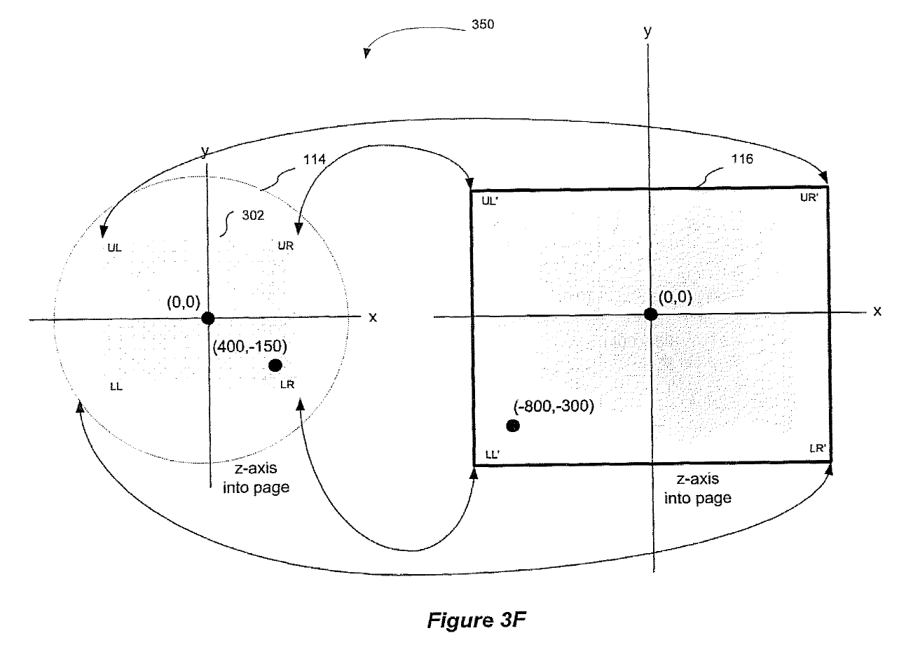

FIG. 3A illustrates a three-dimensional control space 300 in which the interactive control device 102 is situated. The interactive control device 102 is moveable within the three-dimensional control space 300. Accordingly, the three-dimensional control space 300 has an x-axis, a y-axis, and a z-axis. The position of the light source 112 of the interactive control device 102 may be situated at a point (x′, y′, z′). As the interactive control device is moved by the user 104, the light source 112 will be moved to different positions, e.g., (x″, y″, z″).

FIG. 3B illustrates how the imaging device 108 captures the position of the light source 112 of the interactive control device 102, which moves within a control plane 302. The z direction runs between the light source 112 and the imaging device 108. The imaging device 108 captures signals within the imaged portion of the control plane 302 in the three dimensional coordinate space 300. As the user 104 moves the interactive control device 102, various other points having x and y coordinates may be determined within the control plane 302. By capturing the control plane 302, the imaging device 108 allows the user to move the interactive device 108 along the z axis without noticeably affecting the scaling of the coordinates. As discussed above, the focus and zoom capabilities assist in tracking the x and y coordinates irrespective of the z coordinate.

The imaging device 108 provides the two-dimensional position from the control plane 302 to the set top box 110, as illustrated in FIG. 1, which may have a processor. The processor may map the two dimensional data from the control plane 302 to a two-dimensional coordinate space of the display screen in the display system 106, as shown in FIG. 1. For instance, the control plane 302 may be a two-dimensional coordinate space that is smaller or larger than the two-dimensional coordinate space of the display screen. Accordingly, the processor has knowledge of the size of the display screen and may map the relative position of the point (x′, y′) to the corresponding point on the display screen to provide an effective scaling. As a result, the imaging device 108 may be interchangeable and may communicate data through a communication module to the processor, which already has knowledge of the display system 106. The processor effectively provides coordinate translation and may include a coordinate translation module, work in conjunction with a coordinate translation module, or be a part of a coordinate translation module.

FIG. 3C illustrates a two dimensional perspective of the location of the interactive control device 102 with respect to the imaging device 108. The two dimensions illustrated are the y-axis and the z-axis. The x-axis is illustrated as going into the page. Accordingly, the position of the light source 112 captured by the imaging device 108 is within the control plane 302, which is the plane that goes into the page through the y-axis.

FIG. 3D illustrates another two dimensional perspective of the location of the interactive control device 102 with respect to the imaging device 108. The two dimensions illustrated are the x-axis and the y-axis. The control plane 302 is situated along the x-axis and the y-axis within the field of view 114 of the imaging device 108. Further, the point (x′,y′) is within the control plane 302.

FIG. 3E illustrates how the focus and zoom capabilities are implemented for better resolution for the mapping of the coordinates of the location of the light source 112 to the coordinates of the display 116 in the display system 106. If the user 104 is at significant distance from the imaging device 108, the control plane 302 may appear to be small within the field of view 114 of the imaging device 108. Accordingly, the resolution after the mapping may not be optimal. Therefore, the focus and zoom capabilities adjust the size of the control plane 302 so that the size of the control plane 302 with respect to the field of view 114 of the imaging device 108 is sufficient for optimal resolution for the mapping.

FIG. 3F illustrates the mapping 350 of the coordinates of the location of the light source 112 to the coordinates of the display 116 in the display system 106. The two-dimensional perspective, having the x-axis and the y-axis, of the control plane 302 is shown having an origin at (0,0) and the following four corners: upper right (“UR”), upper left (“UL”), lower right (“LR”), and lower left (“LL”). As an example, a location of the light source 112 may have the coordinates of (400, −150). Further, the two-dimensional perspective, having the x-axis and the y-axis, of the display 116 of the display system 106 is shown having an origin at (0,0) and the following four corners: upper right′ (“UR′”), upper left′ (“UL′”), lower right′ (“LR′”), and lower left (“LL′”). The mapping 305 is configured to map the position of the light source 112 from the coordinate system of the control plane 302 into the coordinate system of the display 116 of the display system 106. Accordingly, the processor in the set top box 110 may perform this coordinate translation with the knowledge the movement of the light source 112 and of the size of the two coordinate spaces. For instance, the imaging device 108 captures coordinates of the movement of the light source 112 in the same direction to the actual movement along the y-axis, but in an opposite direction to the actual movement along the x-axis. In other words, if the user 104 moves the light source 112 in a downward direction, the imaging device 108 captures a y coordinate in the downward direction. However, if the user 104 moves the imaging device 108 in a leftward direction, or in a leftward/downward direction, the imaging device 108 captures an x coordinate in the rightward direction. Accordingly, the processor in the set top box 110 maps the coordinates from the control plane 302 to the display 116 in the display system 106 such that the direction of the x coordinate is reversed and the direction of the y coordinate stays the same. Further, the processor in the set top box 110 maps the coordinates from the control plane 302 to the display 116 in the display system 106 to scale the sizing of the different coordinate systems. For instance, the size of the display 116 of the display system 106 may be twice the size of the control plane 302 area in the field of view 114 of the imaging device 108. Accordingly, the processor in the set top box 110 has the knowledge that a two to one ratio exists and should be utilized for scaling in the mapping.

In the example, the processor 110 in the set top box 110 receives the coordinates (400,−150) in the coordinate system of the control plane 302 and maps these coordinates by reversing the direction of the y coordinate and utilizing a scaling ration of two to one. As a result, the mapped coordinates in the coordinate system of the display 116 in the display system 106 are (−800,−300). The processor in the set top box 110 may then provide the coordinates (−800,−300) to a display module, which then provides the coordinates to the display 116 of the display system 106 to display the cursor.

Further, the corners of the control panel 302 are mapped into the corners of the display 116 of the display system 106 based on the direction and ratio discussed above. For instance, UL is mapped to UR′, UR is mapped to UL′, LL is mapped to LR′, and LR is mapped to LL′. The mapped coordinates of the corners are also provided by the processor in the set top box 110 to the display module, which then provides the coordinate of the corners to the display 116 of the display system 106 to display the corners along with the cursor.

In another embodiment, a set top box 110 is not utilized. A stand alone or integrated processor may be utilized for the processing.

In yet another embodiment, a display module is not utilized. The processor in the set top box 110 may send the mapped coordinates directly to the display 116 of the display system 106.

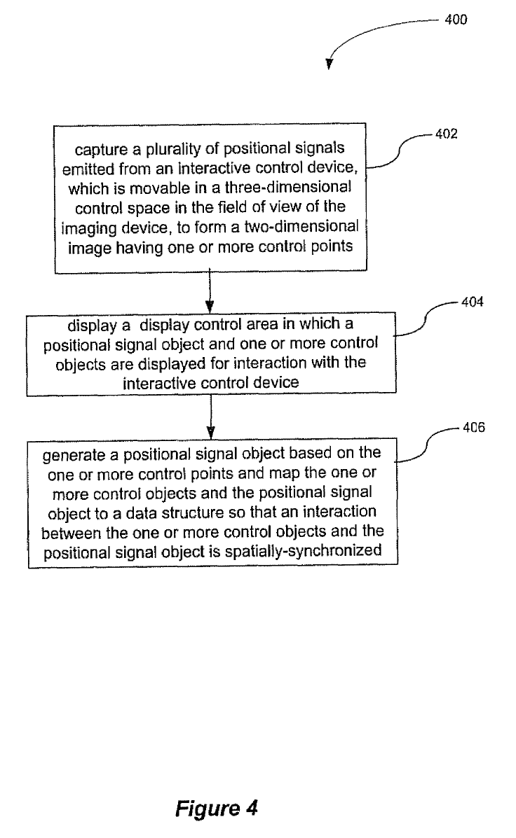

FIG. 4 illustrates a process 400 utilized by the interactive control system. At a process block 402, the process 400 captures a plurality of positional signals emitted from an interactive control device, which is moveable in a three-dimensional control space in the field of view of the imaging device, to form a two-dimensional image having one or more control points. Further, at a process block 404, the process 400 displays a display control area in which a positional signal object and one or more control objects are displayed for interaction with the interactive control device. In addition, at a process block 406, the process 400 generates a positional signal object based on the one or more control points and maps the one or more control objects and the positional signal object to a data structure so that an interaction between the one or more control objects and the positional signal object is spatially-synchronized. The positional signal object and the one or more control objects are rendered in the display control area.

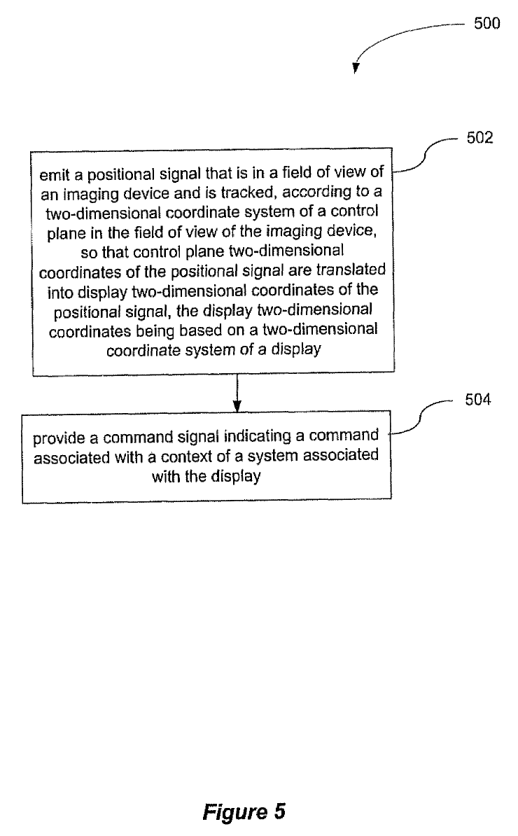

FIG. 5 illustrates a process 500 utilized by the interactive control device 102. At a process block 502, the process 500 emits a positional signal that is in a field of view of an imaging device and is tracked, according to a two-dimensional coordinate system of a control plane in the field of view of the imaging device, so that control plane two-dimensional coordinates of the positional signal are translated into display two-dimensional coordinates of the positional signal, the display two-dimensional coordinates being based on a two-dimensional coordinate system of a display. Further, at a process block 504, the process 500 provides a command signal indicating a command associated with a context of a system associated with the display.

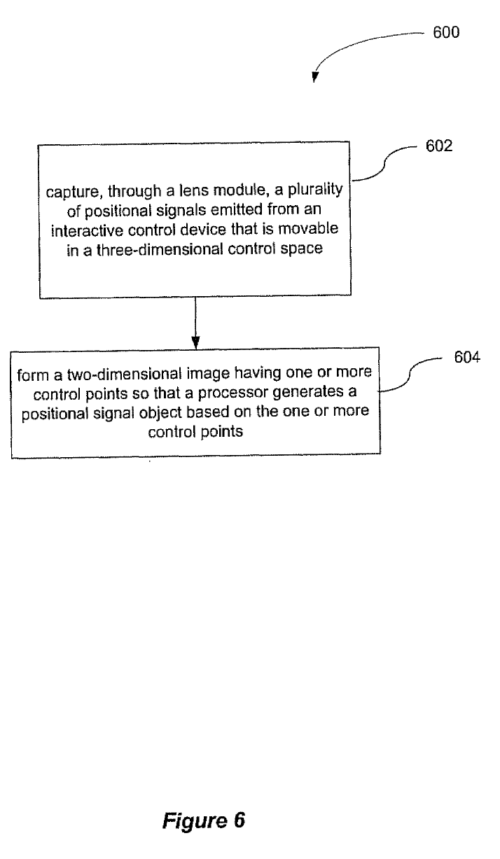

FIG. 6 illustrates a process 600 utilized by the imaging device 108. At a process block 602, the process 600 captures, through a lens module, a plurality of positional signals emitted from an interactive control device that is moveable in a three-dimensional control space. Further, at a process block 604, the process 600 forms a two-dimensional image having one or more control points so that a processor generates a positional signal object based on the one or more control points.

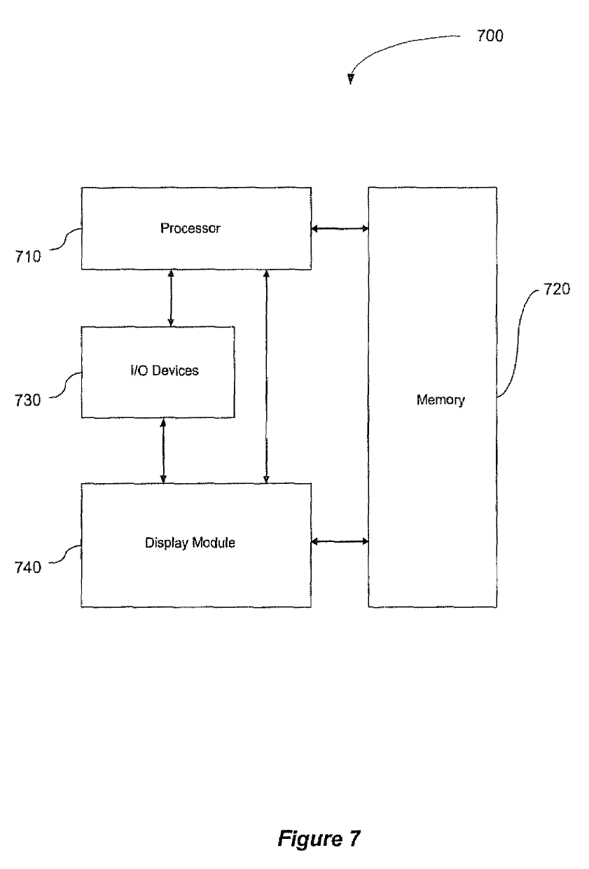

FIG. 7 illustrates a block diagram of a station or system 700 that implements processing of the data received from the interactive control device 102. In one embodiment, the station or system 700 is implemented using a general purpose computer or any other hardware equivalents. Thus, the station or system 700 comprises a processor 710, a memory 720, e.g., random access memory (“RAM”) and/or read only memory (ROM), a display module 740, and various input/output devices 730, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the display module 740 may be implemented as one or more physical devices that are coupled to the processor 710 through a communication channel. The display module 740 may receive pixel data from the processor 710 and send the pixel data to an input/output device, e.g., a display, to be displayed. Alternatively, the display module 740 may be represented by one or more software applications (or even a combination of software and hardware, e.g., using application specific integrated circuits (ASIC)), where the software is loaded from a storage medium, (e.g., a magnetic or optical drive or diskette) and operated by the processor in the memory 720 of the computer. As such, the display module 740 (including associated data structures) of the present disclosure may be stored on a computer readable medium, e.g., RAM memory, magnetic or optical drive or diskette and the like.

It is understood that the method and apparatus, which provide the interactive control system, described herein may also be applied in other types of systems. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

We claim:

1. An apparatus comprising:
an imaging device that captures a plurality of positional signals emitted from an interactive control device, which is moveable in a three-dimensional control space in the field of view of the imaging device, to form a two-dimensional image having one or more control points;
a display that has a display control area in which a positional signal object and one or more control objects are displayed for interaction with the interactive control device; and
a processor that generates a positional signal object based on the one or more control points and maps the one or more control objects and the positional signal object to a data structure so that an interaction between the one or more control objects and the positional signal object is spatially-synchronized, the positional signal object and the one or more control objects being rendered in the display control area.

2. The apparatus of claim 1, wherein the imaging device includes an imaging sensor that has a sensor grid and a lens module.

3. The apparatus of claim 1, wherein the plurality of positional signals are encoded in an infrared pulse format.

4. The apparatus of claim 1, wherein the positional signal object is an image of a cursor that provides indication of the relative position of the interactive control device in the display control area.

5. The apparatus of claim 1, wherein the processor performs a command associated with one of the one or more control objects if the positional signal object is in the same position as the control object in the display control area after the processor maps the one or more control objects and the positional signal object to the display control area and receives a command signal from the interactive control device.

6. The apparatus of claim 1, wherein a command signal emanates from the interactive control device in response to an activation of a button associated with the interactive control device.

7. The apparatus of claim 6, wherein the command signal is interpreted according to a predetermined motion pattern of the interactive control device.

8. The apparatus of claim 1, wherein the display is a television.

9. The apparatus of claim 1, wherein the display is a computer monitor.

10. The apparatus of claim 1, wherein the data structure is a matrix.

11. An apparatus comprising:
a light source that emits a positional signal that is in a field of view of an imaging device and is tracked, according to a two-dimensional coordinate system of a control plane in the field of view of the imaging device, so that control plane two-dimensional coordinates of the positional signal are translated into display two-dimensional coordinates of the positional signal, the display two-dimensional coordinates being based on a two-dimensional coordinate system of a display; and
an activation button that is activated to provide a command signal indicating a command associated with a context of a system associated with the display.

12. The apparatus of claim 11, wherein the command signal is provided from the light source.

13. The apparatus of claim 11, wherein the command signal is provided from a transmission medium distinct from the light source.

14. The apparatus of claim 11, wherein positional data associated with the positional signal is provided to a display module so that a translated position of the light source is indicated on the display.

15. The apparatus of claim 14, wherein an image of a cursor provides indication of the relative position of the light source in the display.

16. The apparatus of claim 11, wherein the positional signal is encoded in an infrared pulse format.

17. The apparatus of claim 11, wherein the command signal is encoded in an infrared pulse format.

18. The apparatus of claim 11, further comprising a sensor that detects a display system and, based upon the detection of the display system, emits one or more control signals detectable by the imaging device to initiate control of the display system.

19. An apparatus comprising:
a lens module; and
an imaging sensor that captures, through the lens module, a plurality of positional signals emitted from an interactive control device that is moveable in a three-dimensional control space and forms a two-dimensional image having one or more control points so that a processor generates a positional signal object based on the one or more control points.

20. The apparatus of claim 19, wherein the imaging sensor also receives a command signal that includes a command which is initiated in relation to an object displayed at display two-dimensional coordinates of the positional signal.
